(19) United States
(12) Patent Application Publication
(10) Pub. No.: US 2002/0043025 A1
(43) Pub. Date: Apr. 18, 2002

(54) Retractable parking space barrier

(76) Inventor: Jose A. Zayas, San Juan, PR (US)

Correspondence Address: JOSE A. ZAYAS, URB. EL PARAISO, 140 GUADALQUIVIR, SAN JUAN, PR, 00926, US

(21) Appl. No.: 09/978,907

(22) Filed: Oct. 17, 2001

Related U.S. Application Data
(60) Provisional application No. 60/241,181, filed on Oct. 17, 2000.

(51) Int. Cl. E06B 11/00

(52) U.S. Cl. 49/33

(57) ABSTRACT

A pivoting channel like post attached with rivets to a base bolted to the pavement, shaped both from stamped and bent metal sheets with some welding. A rigid metal strut stand has riveted axles on both ends that slide on rails cut into the post and the base. A locking device inside the post also shaped from stamped and bent metal is attached with rivets that slide on rails cut in the post. A pedal like component and a handle are riveted or welded to the post. Pressure fasteners will fit into holes in the post to hold sign. Bent metal strips extending from the post attached with screws will hold sign. Staples welded to post and locking device will hold a padlock. Springs are attached to pins or barbs cut from the metal. A second alternative embodiment has a commercially available lock installed in the post, sliding locking device will engage lock, locking device shape will fit type of lock used. A third alternative embodiment has the rigid metal strut stand base end sliding on a rotating threaded shaft connected to a D/C powered motor. The motor is turned on by a radio-wave remote control, will shut down if there's resistance to movement, a sensor will also shut down the motor if there's a vehicle over the barrier. A fourth alternative embodiment is A/C powered instead.

### CLAIM OF PRIORITY

Applicant claims the benefits of priority to U.S. Provisional Application No. 60/241,181, filed Oct. 17, 2000.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to motor vehicles parking barrier devices specifically those installed in a parking space and operated so as to prevent others from using a private or reserved parking space.

Most types of such barriers lay flat under a vehicle when one occupies a parking space then are manually raised and locked in the upright position when the parking space is left vacant. Many of these are straight metal posts or pipes bent into different shapes. Some are motorized and can be operated using a remote control.

U.S. Pat. No. 3,956,853 issued to Montgomery is for a hollow square metal post barrier pivoting on a flange like metal base embedded in the pavement and a pin that when locked will keep the post in the upright position. Signage is applied over the post.

U.S. Pat. No. D253,637 issued to Welbourne shows a post made of two metal strips pivoting on a metal plate base fixed to the pavement. Post will hold a sign and a padlock keeps the post locked in the upright position.

Patent DE3611900 issued to Heinrich is for a remote controlled hollow square metal post barrier pivoting on a metal base with mechanical components that is fixed to the pavement. Driving system and receiver are arranged inside the post. A sensor prevents unintentionally raising the post when a vehicle is standing above. Heinrich claims the post can be easily exchanged and maintained.

U.S. Pat. No. 5,146,710 issued to Caldwell is for a post pivoting on a metal base with mechanical components that rests across a parking space. Post rises to an upright position when vehicle tires press on a floor plate. It is lowered by remote control.

U.S. Pat. No. 5,438,799 issued to Le Faucher of France is for two pivoting posts in a barrier arrangement and a remote controlled drive located in a box like metal base fixed to the pavement.

U.S. Pat. No. 5,452,964 issued to Trougouboff of France is for a hollow rectangular metal post pivoting on a metal base with mechanical components that is fixed to the ground. A pin in the base keeps the post in the upright position when locked. Loop like elements are attached to the upper portion of the post with springs.

Patent GB2294076 issued to Stephens is for a remote controlled post like barrier pivoting on a metal base with mechanical components that is fixed to the pavement resting also across a parking space. A spring mechanism for it's operation is wound every time a vehicle passes over metal plates in the base.

U.S. Pat. No. 5,711,110 issued to Williams is for a channel shaped metal post barrier with a rigid strut stand pivoting on a metal plate base embedded in the pavement. Barrier is locked at the post when raised. There's also a remote controlled motorized version with mechanical components in a base.

Other versions of post barriers have it retracting into the pavement instead of lying flat under a vehicle when one occupies a parking space.

U.S. Pat. No. 4,003,161 issued to Collins is for cylinders that extend telescopically from a pavement embedded container. A locking lever inside the post secures it at various height positions. Other versions of this device consist of one installed above ground and one locked with a padlock that can be removed from the parking space. It is suggested that the post can hold a sign.

U.S. Pat. No. 4,894,654 issued to Serenbetz is for one cylinder on a pavement embedded container that can be raised and locked in an extended position. Can also be used so as to prevent vehicle thefts when installed behind one.

U.S. Pat. No. 5,474,017 issued to Mehebbi, et al. consists also of telescoping sections on a pavement embedded container that are raised and locked in an extended position.

Most of these barriers will require of someone bending or kneeling so as to operate them. Height is restricted in some and others may become useless if hit by a vehicle. Those that go into the pavement can't be used in parking spaces above ground. Hardly any use of signs is considered along with the barrier.

U.S. Pat. No. 4,190,379 issued to Toro Sosa, et al. from Spain is for a U-shaped bent pipe barrier pivoting on a metal plate base fixed to the pavement. A padlock keeps the barrier in an upright position.

U.S. Pat. No. 4,875,797 issued to Hartwing is for an arch shaped bent pipe barrier pivoting on metal flanges fixed to the pavement. A padlock keeps the barrier in an upright position. There are springs on both leg ends.

Patent EP363241 issued to Trougouboff, EP849400 issued to Bolzani and FR2757887 issued to Cavanna consist of arch shaped bent pipes barriers pivoting on metal flanges fixed to the pavement and a straight pipe used as a strut stand. Compression springs, locks and pins are used to keep the barrier in an upright position. Cavanna's proposal is for a remote controlled motorized version.

U.S. Pat. No. 5,167,093 issued to Hamilton is for an inverted V-shape bent pipe barrier attached to a metal channel hinged to a metal plate base fixed to the pavement. Barrier is kept in the upright position when the channel is locked into the base. Can also be used so as to prevent vehicle thefts when installed behind one.

Patent FR2748762 issued to Vion is for an arch shaped bent pipe barrier and a three sections pipe and channel like metal base fixed to the pavement where a motorized jack can move the barrier up and down. The system is fed by a rechargeable battery. Jack stops if an obstruction is sensed.

As with the post barriers most pipe barrier types will require of someone bending or kneeling so as to operate them. Because of their shape and size it may be easier for a vehicle to go over them and get stuck or tangled in them. They don't look suited for signs use either.

Other types of barriers rely on mechanical arms.

Patent EP373084 issued to Pichon and Patent EP571305 issued also to Pichon and Vulin are for such a device and are installed next to a parking space.

Trouble with this solution is that a person will find hard getting out and into his vehicle if another one is parked next to it because of the space such a device takes.

Still other types are so unique they don't fit any of these classifications.

Patent DE3203436 issued to Steinhanses is for two fixed posts on each side of the entry to a parking space and a flexible barrier that winds on each. When released a vehicle pushes the barrier to park.

U.S. Pat. No. 4,941,284 issued to Stoller is for a remote controlled L-shaped post that extends from the back of the parking space into it at windshield level. It turns out of the way when a vehicle is parked.

U.S. Pat. No. 5,165,200 issued to Oga is for a stationary base fixed to the pavement and a cushioned pylon that the space owner pushes with it's vehicle. The pylon is drawn back to the base by a remote controlled motorized pulley and remains locked there when the parking space is vacant.

These solutions may not deter someone from attempting to park in a private parking space.

This patent specification is for a retractable parking barrier that is easier to install and operate, shape performs and protects the components better, signs stand out and allows for four operating alternative embodiments instead of one or two.

### BRIEF SUMMARY OF THE INVENTION

The barrier consists of a pivoting metal channel like post locked in the upright position when a parking space is left vacant. Will lay flat under a vehicle when not in use between two triangular shaped sides of a metal plate base. A rigid strut stand(s) is attached to the post and the base. Base is bolted and/or anchored into concrete or asphalt at about the center of a parking space along it's length. Interchangeable reflective signs with such messages as “NO PARKING”, “PRIVATE”, “RESERVED” are fixed to the post front side. Another sign is placed over the post attached to it with metal strips extending from the top. Those will look like a “STOP”, “DO NOT ENTER” or any other standard road sign or have any other shape and announcement. Sign will lay flat on the pavement when the post is down. When installed in a sloping parking space the barrier can be adjusted for angle correction so that the post remains in true vertical position when raised. If the post is hit it will move backwards and then return to it's proper position so as to prevent damage to vehicle or barrier. If hit hard enough post will go down so as to prevent major damage.

The post is raised by pressing with a foot on a pedal at the lower portion of the post then grabbing with the hand a handle at the top of the post. When vertical position is achieved a padlock will keep the post locked in the upright position. Post returns to the base by it's own weight. A second alternative embodiment of the barrier has a lock installed in the post to lock the post in the upright position. In a third alternative embodiment a radio remote controlled motor powered by batteries drives the post up or down. A sensor will shut down the motor if there's a vehicle over the barrier. In a fourth alternative embodiment the motor is powered on site.

According to another aspect of the invention, a parking barrier is especially suited to prevent unauthorized use of a reserved parking space or access to a restricted area comprising. The parking barrier includes an elongated base, an elongated arm, a sign, and a foot pedal. The elongated base has side walls that define an interior channel wherein the elongated base has a first end and a second end. The elongated arm is approximately the same length as the elongated base and has a top and a bottom end. The bottom end is pivotally connected to the first end of the elongated base so that the elongated arm rests within the interior channel of the elongated base at a substantially horizontal orientation. The sign removably attaches to a top end of the elongated arm. The sign extends beyond the second end of the elongated base when the elongated arm rests within the interior channel of the elongated base. The foot pedal is connected between the elongated base and the arm proximate the first end of the elongated base and the bottom of the elongated arm. The foot pedal has a contracted and extended position. The operation of the foot pedal from the contracted to the extended position moves the elongated arm from the substantially horizontal orientation to a substantially vertical orientation so that the elongated arm prevents the passage of an automobile past the parking barrier. The sign moves with the elongated arm from a substantially horizontal orientation to a substantially vertical orientation so that text or graphics associated with the sign becomes visible to passing vehicles.

According to further aspects of the invention, the side walls of the elongated base include a right-triangular beam extending along the length of the elongated base from the first to the second end. Each of the right-triangular beams includes a vertical, a horizontal and a diagonal side. The vertical sides of the right-triangular beams each define a side wall of the interior channel. The elongated base also includes a plate extending horizontally along it's length. The plate connects the horizontal sides of the right triangular beams. The plate defines a bottom of the interior channel. The elongated arm is approximately three to five feet in height. The elongated arm defines at least one slot that engages a bar pivotably connected to the base. A lock connects with the arm and the bar to prevent movement of the bar with respect to the arm. In the vertical position the lock prevents movement of the arm from the vertical position to the horizontal position by an unauthorized person. The foot pedal is positioned within the interior channel of the elongated base. A plurality of signs are included as a kit. Each of the signs bears a different message.

According to further aspects of the invention, an optical detector is positioned along the elongated arm. The optical detector is configured to prevent movement of the elongated arm from a substantially vertical orientation upon detection of an automobile or other obstruction above the elongated arm.

According to another aspect of the invention, a parking barrier is formed from a channel, a post, a sign and a lift. The channel has a bottom and a pair of parallel side walls. The bottom defines a plurality of holes for use in fixedly attaching the channel to a driving surface. The channel has a pivot end and a sign end. The channel has a low profile to fit underneath a standard automobile. The post has a bottom end and a top end. The bottom end is pivotally attached to the channel proximate the pivot end of the channel so that the post may rotate from a horizontal position to a vertical position. The post in the horizontal position fits substantially within the low profile of the channel. The post in the vertical position extends substantially above the channel to create a barrier to passing automobiles. The sign is connected to the post proximate the top end. The sign extends upward from the post when the post is in the vertical position so that the text associated with the sign appears at approximately the same level as the windshield of an automobile. The sign extends horizontally from the post and past the sign end of the channel when the post is in the horizontal position. The lift is connected to the channel and the post. Operation of the lift moves the post from the horizontal position to the vertical position and thereby prevents access to a parking space or other restricted area.

According to further aspects of the invention, the channel is less than five inches in height. The lift is an electric motor activated by a radio-wave remote control. The angular position of the post is determined by an adjustable strut. The strut is formed of two metal bars adjustably fastened together so that the length of the strut can be lengthened or shortened.

Further aspects of the invention will be appreciated through the drawings and detailed description that follows.

### BRIEF DESCRIPTION OF THE SEVERAL VIEWS OF THE DRAWINGS

FIG. 1 is a front view with the post in the upright position.

FIG. 2 is a top view with the post resting in the base.

FIG. 3 is a front view with the post resting in the base.

FIG. 4 is a rear view with the post in the upright position.

FIG. 5 is a partial front view with the post in the upright position.

FIG. 6 is a partial rear view with the post in the upright position.

FIG. 7 is a partial rear view with the post in the upright position.

FIG. 8 is a side view with the post in the upright position and resting in the base.

FIG. 9 is a partial side view of the post with the post in the upright position.

FIG. 10 is an interior view of the post and base with the post in the upright position.

FIG. 11 is a partial interior view of the post and base with the post in the upright position.

FIG. 12 is an interior view of the post and base with the post in the upright position.

FIG. 13 is a front view with the post in the upright position.

### DETAILED DESCRIPTION OF THE INVENTION

Barrier post and base shape will be achieved by stamping and bending metal sheets of about 0.125 of an inch gauge. Welding and rivets will be part of a finished product. Construction should be sturdy enough for a barrier to carry the weight of a vehicle over it.

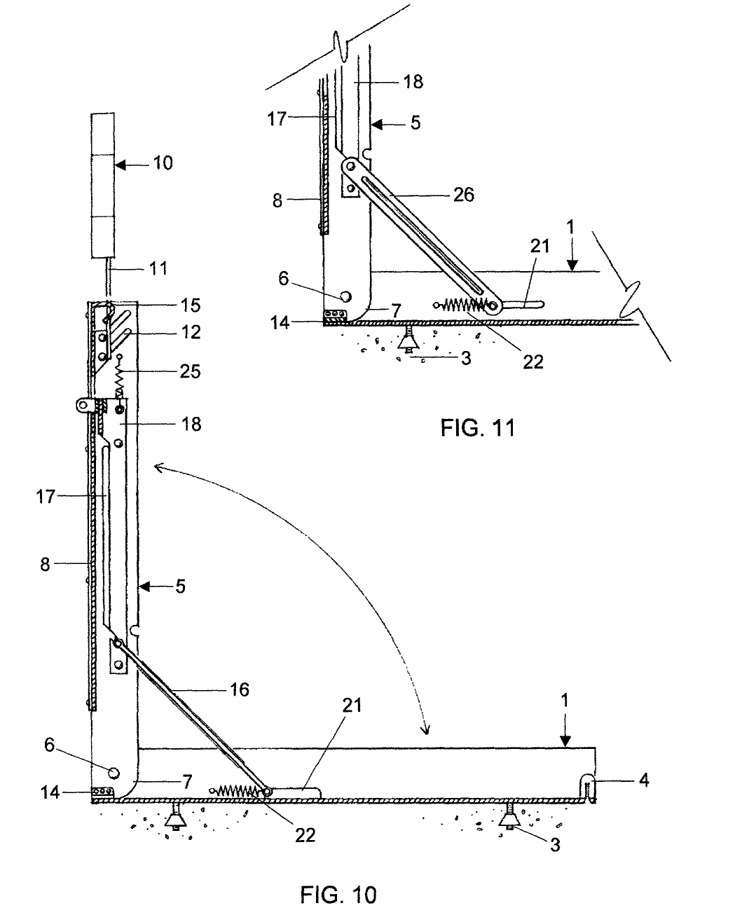

The base (#1) regarded as one piece has two right angle triangular shaped sides slanting between 30° to 60° with an angle preference of 45°. Vertical sides are welded to the bottom plate. Four holes (#2, FIGS. 2 & 8) for anchoring bolts (#3) are provided. Holes in the slanting sides should have enough diameter so as to let a wrench socket in, those in the bottom plate have an elongated shape so as to make installation easier. A rubber (#4, FIG. 10) bumper for the post is placed over the bottom plate at the rear end of the base in the manually operated versions of the barrier. It is attached with flat inserts from beneath the bottom plate or pushed into metal barbs cut from the bottom plate.

The post (#5) regarded as one piece too is attached to the base with two rivets (#6, FIG. 10) that allow rotation. Washers will provide enough space between post and base so that post other rivets heads won't touch the base vertical sides when down. At the low end rear side of the post comers are cut in a circular way (#7, FIG. 10) so as to permit pivoting movement while low end front side corners will prevent further movement when vertical position is achieved. Post legs length is variable and will be determined by the size of the sign (#8) to be attached to the post front side and post sturdiness criteria. Holes are provided in the front side of the post for the pressure fasteners (#9) that will hold the sign to fit in. Sign can be either made of plastic or metal.

The post should not project over the base vertical sides when down as shown in FIG. 3. The barrier should keep a low profile when not in use so the post should remain as shallow as possible. Base wide measure will be determined by the post depth and the angle used at the base sides. Post and base will have the same length. Post length should be enough for a sign over the post being at about the same level of a S.U.V. windshield.

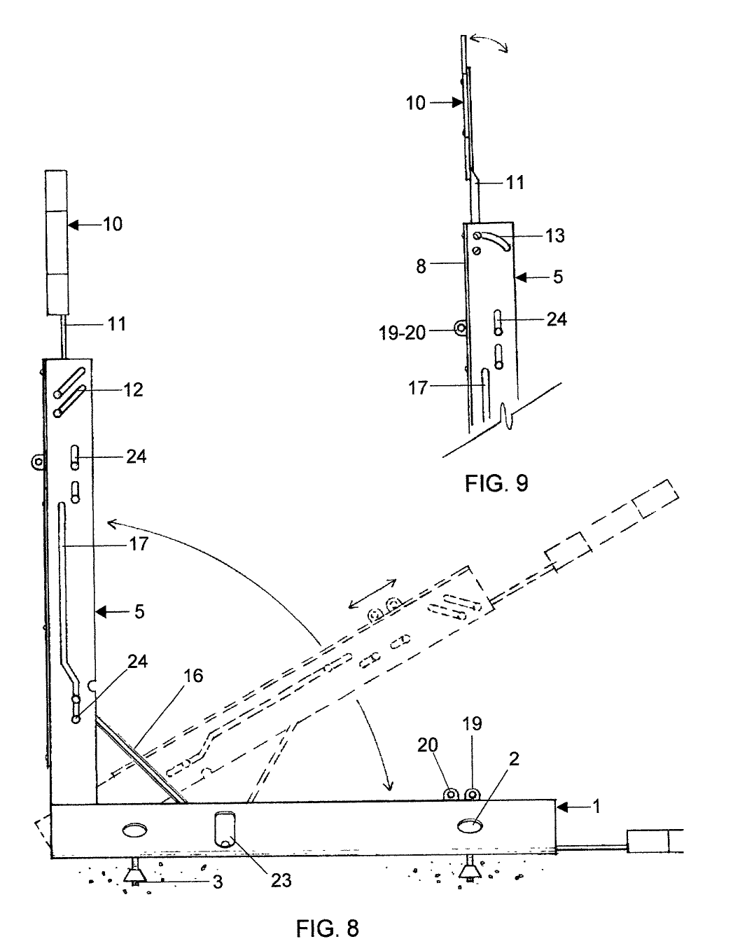

A molded plastic sign (#10) is attached over the post with metal strips (#11) extending from the top of the post. Distance from the post to the sign is variable. Metal strips that slide on rails cut in the post at a 45° angle (#12, FIGS. 8 & 10) will allow a sign to lay flat on the pavement when the post is down. This can prevent damage to the sign if run over by a vehicle tire. When this is of no concern the sign can also be attached as shown in FIG. 9 made either of plastic or metal. If the sign gets hit screws holding the sign at the post (#13) will allow for backward movement. Torsion springs in the screws will restore the sign to it's proper place. Metal strips incorporating springs could be used instead.

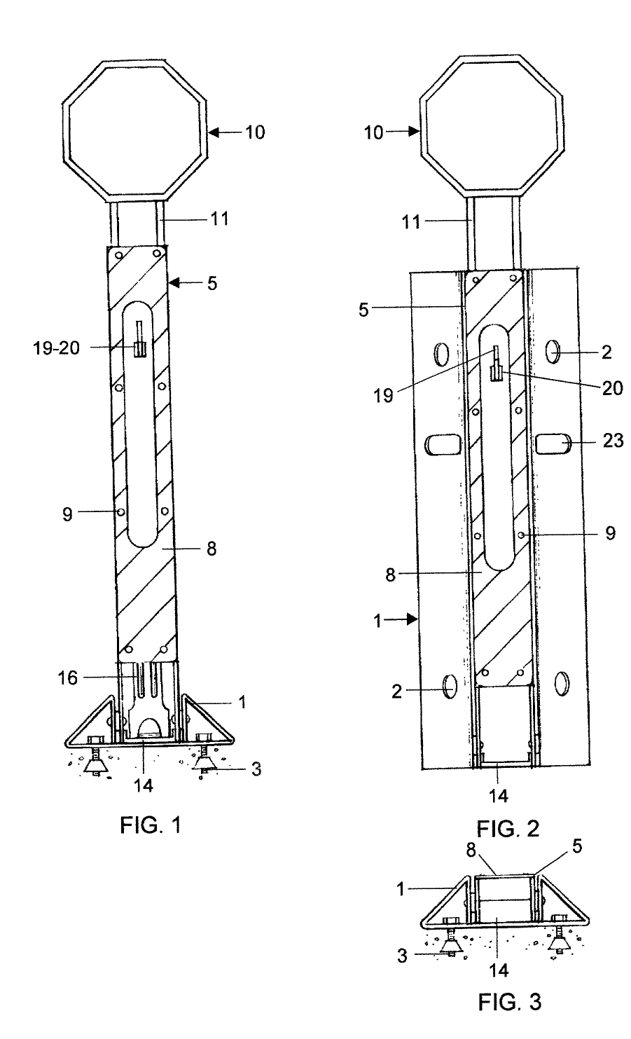

A pedal like component (#14, FIGS. 1, 3, & 10) made of stamped and bent metal is attached with rivets or welded to the low end of the post. At the other end of the post the post metal is bent to form a handle (#15, FIG, 10) or a handle like component of stamped and bent metal can be attached with rivets or welded too. The handle will leave space on both sides for the attachment of metal strips that will hold a sign over the post. The post is raised by pressing on the pedal then grabbing the handle with the hand. The pivoting movement puts in motion a rigid metal strut stand (#16) with axles on both ends. One of the axles slides on rails (#17, FIGS. 8 & 10) cut into the post sides, ends are riveted to keep the axle in place. As the axle slides down the post it will slip into a sliding locking device (#18, FIG. 10) that moves downwards. A staple attached to this device (#19, FIGS. 2 & 10) also slides downwards between two other fixed staples (#20, FIGS. 1 & 2) at the front of the post. When post vertical position is achieved the sliding locking device can't move any further. A padlock attached then to the three staples won't allow any movement of the sliding locking device and the post will be locked in the upright position because the sliding locking device won't allow any movement of the axle and stand either. When the padlock is removed the post falls to the base by it's own weight. The handle in the post will hit a bumper (#4, FIG. 10) at the base. At the base the other stand axle will only move if the post gets hit, ends are riveted to keep the axle in place.

If the post gets hit the axle at the base will slide on rails cut into the vertical sides of the base (#21, FIG. 10) allowing backward movement of the stand and post so as to prevent damage to vehicle or barrier. Post angle of deflection is variable. Springs (#22, FIG. 10) attached to the axle and to pins or metal barbs cut from the base vertical sides will return the stand and post to it's proper position. If the post is hit hard enough the stand axle at the base, made of a softer metal or plastic, will break apart and the post will go down so as to prevent major damage to post or vehicle. This axle can be replaced. A cut (#23, FIGS. 2 & 8) in the slanting sides of the base provides space for this operation.

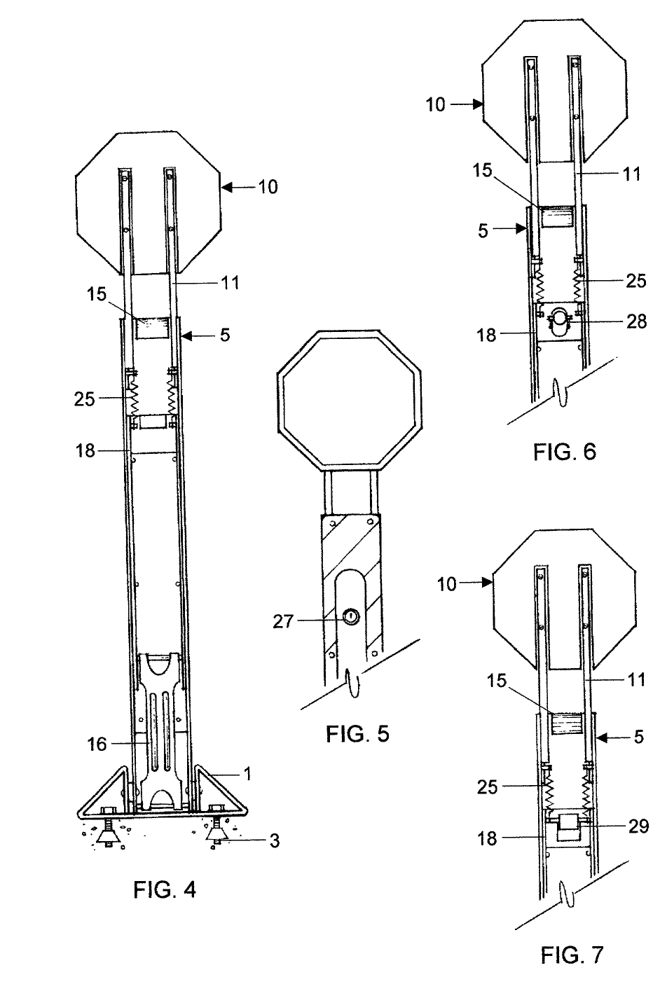

The sliding locking device (#18, FIG. 10) is regarded too as one piece shaped of stamped and bent metal. It is installed inside the post using rivets that slide on rails cut into the post sides (#24, FIG. 8). Springs (#25, FIGS. 4 & 10) attached to pins or metal barbs cut from the post and the sliding locking device will keep it in place so it can be engaged by the stand axle when the post is raised. Staples are welded to the sliding locking device and post.

The barrier can also be fitted with a couple of rigid metal strut stands instead of one (#26, FIG. 11). A shock absorber can also be used for a stand replacing the springs at the base. Stand(s) should be about ⅖ of total post length so that all components can properly fit inside the post and base when the post is down. Will remain in a 45° angle with the base when the post is in the upright position.

When the barrier is installed in a sloping parking space an adjustable length stand or shock absorber will provide for angle correction so that the post remains in true vertical position when raised. Two rigid metal pieces sliding one on the other tightened with a nut will do for an adjustable length stand.

A second alternative embodiment of the barrier uses a commercially available lock installed in the post (#27, FIG. 5) instead of a padlock to lock the post in the upright position. Operation remains the same. The sliding locking device instead of having a staple for a padlock will engage the lock. This can be achieved in different ways depending on the type of lock used and the sliding locking device shape will vary accordingly. In FIG. 6 two spring bolts in the lock (#28) will prevent backward movement of the sliding locking device (#18) when vertical position is achieved and the post remains locked in the upright position because the sliding locking device won't allow any movement of the axle and stand either. In FIG. 7 a rod in the sliding locking device (#18) is grabbed by a slam action strike lock (#29) preventing any movement of the sliding locking device so the post remains locked in the upright position as described before. When unlocked the post falls to the base by it's own weight.

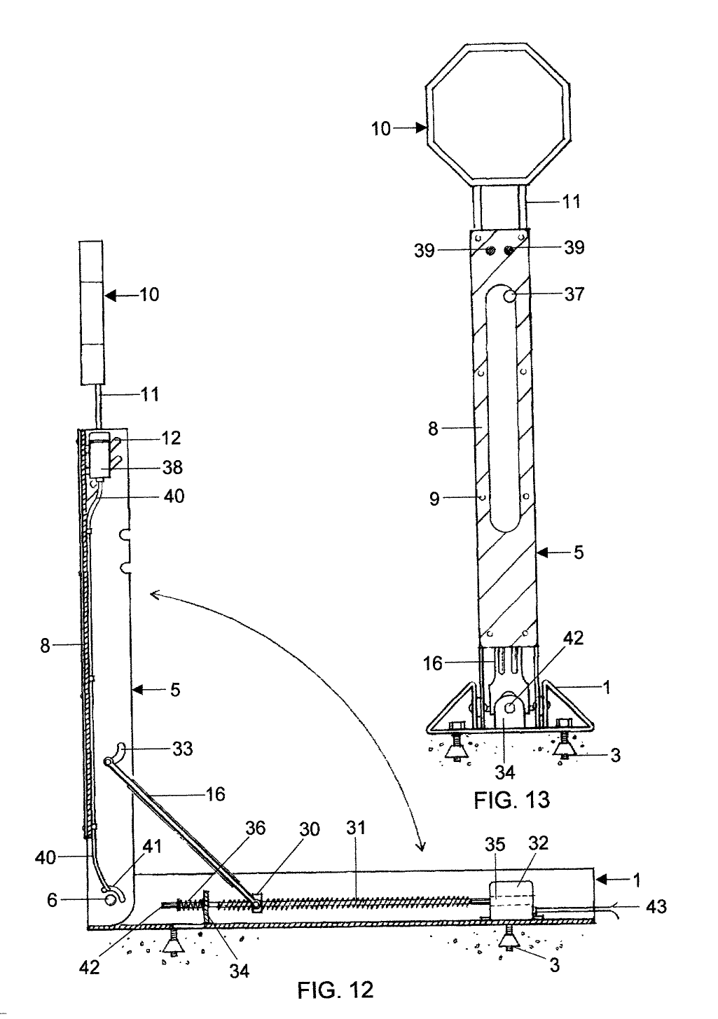

In a third alternative embodiment of the barrier as shown in FIG. 12 the rigid metal strut stand (#16) connects at the base end to axles that extend from a ring (#30) that slides along a rotating threaded shaft (#31). Axles slide on rails cut into the base vertical sides, ends are riveted to keep them in place. The shaft in turn connects to a D/C battery powered motor (#32) placed at the rear end of the base inside a water proof box. The other side of the stand has an axle that slides on rails cut into the post sides (#33) in a shape that will allow the sliding axle to raise the post when the post is down at the base in the horizontal position. Axle ends are also riveted to keep them in place.

When the post is down shaft and motor remain enclosed and protected from the tires of a moving vehicle. Shaft front end side is mounted on a bracket cut from the base bottom plate (#34, FIG. 12). A ball bearing for the shaft to fit in can be attached to the bracket. The other end of the shaft could slide inside the motor (#35) if the post gets hit and the stand pushes on the shaft so as to prevent damage to vehicle or barrier. A spring (#36) at the shaft front end side will return the shaft to it's proper place. If the post is hit hard enough the stand axle at the post, made of softer metal or plastic, will break apart and the post will go down so as to prevent major damage to post or vehicle.

The motor drives the post up or down when turned on by a radio-wave remote control. Will shut down when the post gets to the vertical or the horizontal position or if the post finds resistance to movement. A sensor will also shut down the motor if there's a vehicle over the barrier. Receiver and sensor could be fitted inside the motor box. When installed this way a hole in the post and sign (#37, FIG. 13) aligned with the sensor when the post lays down is provided so that the sensor does not confuses the post with a vehicle.

Rechargeable batteries are placed inside a locked water proof metal or plastic battery pack (#38, FIG. 12) fitted inside the post at the top. Lights in the battery pack seen from the post front side (#39, FIG. 13) tell if battery charging is needed. The electric cord (#40, FIG. 12) from the battery pack to the motor will travel from the post to the base through a circular cut in the low end rear side of the post (#41, FIG. 12). Metal barbs cut from the post and base will hold the cord in place.

Shaft front side (#42, FIG. 12) ends in a cross section that allows the post to be raised or lowered with a wrench like tool in the event of a power failure.

As with the other alternative embodiments the barrier can also be fitted with two rigid metal strut stands instead of one (#26, FIG. 11). A shock absorber can also be used for a stand replacing the spring in the shaft. Stand(s) should be about ⅖ of total post length so that all components can properly fit inside the post and base when the post is down.

As with the other alternative embodiments also when the barrier is installed in a sloping parking space an adjustable length stand or shock absorber will provide for angle correction so that the post remains in true vertical position when raised. Two rigid metal pieces sliding one on the other tightened with a nut will do for an adjustable length stand. Angle correction is also possible by preventing the sliding ring in the shaft traveling beyond certain point in the shaft or by adjusting the motor to a predetermined number of turns.

A fourth alternative embodiment of the barrier is A/C powered on site instead. An electric cord from the motor box extends from the rear of the base (#43, FIG. 12).

I claim:

1. A parking barrier especially suited to prevent unauthorized use of a reserved parking space or access to a restricted area comprising:
an elongated base having side walls that define an interior channel wherein the elongated base has a first and a second end;
an elongated arm approximately the same length as the elongated base having a top and a bottom end, wherein the bottom end is pivotally connected to the first end of the elongated base so that the elongated arm rests within the interior channel of the elongated base at a substantially horizontal orientation, and wherein the elongated arm defines at least one slot;
a sign removably attached to a top end of the elongated arm and which extends beyond the second end of the elongated base when the elongated arm rests within the interior channel of the elongated base; and
a foot pedal connected between the elongated base and the arm proximate the first end of the elongated base and the bottom of the elongated arm, and having a contracted and extended position, wherein operation of the foot pedal from the contracted to the extended position moves the elongated arm within the interior channel from the substantially horizontal orientation to a substantially vertical orientation so that the elongated arm prevents the passage of an automobile past the parking barrier and wherein the sign moves with the elongated arm from a substantially horizontal orientation to a substantially vertical orientation so that text or graphics associated with the sign becomes visible to passing vehicles; and
a sliding locking mechanism including a bar pivotally connected to the base and engaging the at least one slot in the arm, and a lock connected with the arm and the bar to prevent movement of the bar with respect to the arm when the arm is in the vertical position and to thereby prevent movement of the arm from the vertical position to the horizontal position by an unauthorized person.

2. The parking barrier of claim 1, wherein the side walls of the elongated base each comprise a right-triangular beam extending along the length of the elongated base from the first to the second end, wherein a first side of the right-triangular beam extends vertically and a second side of the right-triangular beam extends horizontally and a third side forming the hypotenuse of the right-triangular beam extends diagonally from the first side to the second side of the right triangular beam, and wherein the first side of the right-triangular beams each define a side wall of the interior channel.

3. The parking barrier of claim 2, wherein the elongated base further comprises a plate extending horizontally along the length of the elongated base from the first end to the second end, wherein the plate connects between the right-triangular beams along the second side of the right-triangular beams, and wherein the plate defines a bottom of the interior channel.

4. The parking barrier of claim 1, wherein the elongated arm is approximately three to five feet in height.

5. The parking barrier of claim 1, wherein the foot-pedal is positioned within the interior channel of the elongated base.

6. The parking barrier of claim 1, further comprising a kit including a plurality of signs each having a different text or graphical message.

7. The parking barrier of claim 1, further comprising an optical detector positioned along the elongated arm and configured to prevent movement of the elongated arm from the substantially horizontal orientation to the substantially vertical orientation upon detection of a vehicle or other obstruction above the elongated arm.

8. A parking barrier comprising:
a channel having a bottom and a pair of parallel side walls, wherein the bottom defines a plurality of holes for use in fixedly attaching the channel to a driving surface, wherein the channel has a pivot end and a sign end, and wherein the channel has a low profile to fit underneath a standard automobile;
a post having a bottom end and a top end, the bottom end being pivotally attached to the channel proximate the pivot end of the channel so that the post may rotate from a horizontal position to a vertical position, wherein the post in the horizontal position fits substantially within the low profile of the channel, and wherein the post in the vertical position extends substantially above the channel to create a barrier to passing automobiles;
a sign connected to the post proximate the top end, wherein the sign extends upward from the post when the post is in the vertical position so that text associated with the sign appears at approximately the same level as the windshield of an automobile, and wherein the sign extends horizontally from the post and past the sign end of the channel when the post is in the horizontal position; and
a lift connected to the channel and the post, wherein operation of the lift moves the post from the horizontal position to the vertical position and thereby prevents access to a parking space or other restricted area.

9. The parking barrier of claim 8, wherein the channel is less than five inches in height.

10. The parking barrier of claim 9, wherein the channel is formed by parallel triangular beams that extend from the pivot and to the sign end.

11. The parking barrier of claim 8, wherein the post fits entirely within the channel when in the horizontal position.

12. The parking barrier of claim 8, wherein the lift comprises a foot-pedal.

13. The parking barrier of claim 8, wherein the lift comprises an electric motor activated by a radio-wave remote control.

14. The parking barrier of claim 8, further comprising a plurality of signs each of which may be removably connected to the post proximate the top end, wherein each of the plurality of signs presents a different text or graphic message.

15. The parking barrier of claim 8, further comprising:
a strut connected between the post and the channel; and
a lock operable to fix the position of the strut along the post so that the post is held in the vertical position until the lock is removed.

16. The parking barrier of claim 15, wherein the strut comprises a first and a second metal bar adjustably fastened together so that the length of the strut can be lengthened or shortened when the parking barrier is mounted on an inclined surface so that the post obtains a substantially vertical orientation even on the inclined surface.

17. A barrier especially suited for selectively preventing the passage of an automobile comprising:
a base defining a plurality of holes configured to mount the base on a parking surface;
an arm pivotally connected to the base so that the arm may rotate from a blocking position to prevent the passage of an automobile to a passing position to permit the passage of an automobile, wherein the arm in the passing position obtains a low profile to fit beneath the underbody of a standard automobile;
a sign extending from a top portion of the arm and displaying a text or graphic message at the same level as the windshield of an automobile when the arm is in the blocking position;
a lock connected between the base and the arm and operational to prevent movement of the arm from the blocking position to the passage position; and
a foot pedal connected between the base and the arm and operational to move the arm from the passage position to the blocking position.

18. The barrier of claim 17, wherein the base comprises a pair of triangular beams extending along the length of the base and defining an elongated channel, wherein the hypotenuse of the triangular beams slopes upward from the parking surface to define an interior channel protected by the triangular beams, and wherein the arm in the passing position fits within the channel and wherein the sign extends beyond the channel.

19. The barrier of claim 17, wherein the base has a profile of not greater than five inches.

20. The barrier of claim 17, wherein the sign extends to a height of at least four feet when the arm is in the blocking position.
